(19) United States
(12) Patent Application Publication
(10) Pub. No.: US 2017/0137313 A1
(43) Pub. Date: May 18, 2017

(54) POWDER, PROCESS OF MAKING THE POWDER, AND ARTICLES MADE THEREFROM

(71) Applicant: CORNING INCORPORATED, CORNING, NY (US)

(72) Inventors: ANTOINE GASTON DENIS BISSON, CORNING, NY (US); ROY JOSEPH BOURCIER, CORNING, NY (US); MALLANAGOUDA DYAMANAGOUDA PATIL, CORNING, NY (US)

(21) Appl. No.: 15/353,403

(22) Filed: Nov. 16, 2016

Related U.S. Application Data
(60) Provisional application No. 62/256,862, filed on Nov. 18, 2015.

(51) Int. Cl. C03B 11/06; B22F 1/02

(52) U.S. Cl. CPC C03B 11/06; B22F 1/02; B22F 5/007

(57) ABSTRACT

A powder useful for making a mold utilized for shaping glass-based materials includes at least about 50% by weight nickel. Metal oxides that are not miscible with nickel may be dispersed within the powder in an amount in a range from about 0.2 to about 15% by volume. A mold made from the powder may have a mold body having a composition comprising at least 50% by weight nickel and a metal oxide that is not miscible with nickel in an amount in a range from about 0.2 to about 15% by volume, a nickel oxide layer on a surface of the mold body wherein the nickel oxide layer has first and second opposing surfaces, the first surface of the nickel oxide layer contacts and faces the surface of the mold body, the second surface of the nickel oxide layer includes a plurality of grains, and the plurality of grains has an average grain size of about 100 μm or less.

### CROSS-REFERENCE TO RELATED APPLICATIONS

This application claims the benefit of priority under 35 U.S.C. §119 of U.S. Provisional Application Ser. No. 62/256,862 filed on Nov. 18, 2015, the content of which is relied upon and incorporated herein by reference in its entirety.

### BACKGROUND

Field

The present specification generally relates to a powder, more specifically, to a powder for making molds for shaping glass-based materials and articles and molds made from the powder.

Technical Background

The current demand in modern electronics devices for thin, three dimensional glass-based substrates that have very high levels of surface quality has produced a need to find processes that are commercially capable of providing defect-free shaped glass-based substrates. Shaped glass forming generally refers to high temperature processes that involve heating the glass to be formed to a temperature at which it can be manipulated, and then conforming it to a mold to achieve the designed shape. Classic methods of shaping glass substrates include television tube forming, where a softened glass gob is pressed between male & female molds, and bottle forming, where glass is blown in a pair of hollowed molds.

In shaping operations, the quality of the mold surface is important for producing cosmetically acceptable glass quality that can be polished into a final glass article with minimal polishing. Molds can have a surface texture that reproduces onto the glass surface during the molding process. This is undesirable and it can be difficult to remove the reproduced texture from the shaped glass with polishing. Thus a need exists to control the mold surface quality to minimize or reduce the possibility of a surface texture on the mold surface that reproduces onto the shaped glass-based substrate.

### SUMMARY

A first aspect is directed to a powder including at least about 50% by weight nickel and a metal oxide that is not miscible with nickel dispersed within the powder in an amount in a range from about 0.2 to about 15% by volume.

In a second aspect according to the first aspect, the metal oxide is selected from the group consisting of zirconia, ceria, yttria, tantalum(V) oxide, and combinations thereof.

In a third aspect according to the first or second aspect, the powder further includes a plurality of particles, wherein an average particle size of the powder is in a range from about 5 nm to about 1,000 nm.

In a fourth aspect according to any one of the first through third aspects, the powder further includes a plurality of particles, wherein the oxide is interdispersed with the nickel.

In a fifth aspect according to the fourth aspect, the particles may be coated with the oxide.

In a sixth aspect according to any one of the first through fifth aspects, the powder further includes a plurality of particles, wherein the oxide is intradispersed with the nickel.

In a seventh aspect according to the sixth aspect, the oxide may be within an interior of the particles.

In an eighth aspect according to any one of the first through seventh aspects, the powder further includes a plurality of particles, wherein the oxide is interdispersed with the nickel in a first portion of the plurality of particles and intradispersed with the nickel in a second portion of the plurality of particles.

In a ninth aspect according to any one of the first through eighth aspects, the oxide is dispersed within the powder in an amount in a range from about 0.2 to about 2% by volume.

In a tenth aspect according to any one of the first through ninth aspects, the oxide is zirconia.

In an eleventh aspect according to any one of the first through tenth aspects, the oxide is ceria.

A twelfth aspect is directed to an article a powder including at least about 50% by weight nickel, a metal oxide that is not miscible with nickel dispersed within the powder in an amount in a range from about 0.2 to about 15% by volume, and a plurality of grains, wherein the plurality of grains has an average grain size of about 100 μm or less.

In a thirteenth aspect according to the twelfth aspect, the metal oxide is selected from the group consisting of zirconia, ceria, yttria, tantalum(V) oxide, and combinations thereof.

In a fourteenth aspect according to the twelfth or thirteenth aspect, the oxide is in an amount in a range from about 0.2 to about 2% by volume.

In a fifteenth aspect according to any one of the twelfth through fourteenth aspects, the oxide is zirconia.

In a sixteenth aspect according to any one of the twelfth through fifteenth aspects, the oxide is ceria.

In a seventeenth aspect according to any one of the twelfth through sixteenth aspects wherein the plurality of grains has an average grain size of about 50 μm or less.

An eighteenth aspect is directed to a mold including a mold body having a composition including at least 50% by weight nickel and a metal oxide that is not miscible with nickel in an amount in a range from about 0.2 to about 15% by volume and a nickel oxide layer on a surface of the mold body wherein the nickel oxide layer has first and second opposing surfaces, the first surface of the nickel oxide layer contacts and faces the surface of the mold body.

In a nineteenth aspect according to the eighteenth aspect, the second surface of the nickel oxide layer includes a plurality of grains, and the plurality of grains has an average grain size of about 100 μm or less.

In a twentieth aspect according to the eighteenth or nineteenth aspect, the second surface of the nickel oxide layer includes a plurality of grains, and the plurality of grains has an average grain size of about 50 μm or less.

In a twenty first aspect according to any one of the eighteenth through twentieth aspects, the metal oxide is selected from the group consisting of zirconia, ceria, yttria, tantalum(V) oxide, and combinations thereof.

In a twenty second aspect according to any one of the eighteenth through twentieth first aspects, the oxide is zirconia.

In a twenty third aspect according to any one of the eighteenth through twenty second aspects, the oxide is ceria.

In a twenty fourth aspect according to any one of the seventeenth through twenty third aspects, the oxide is in an amount in a range from about 0.2 to about 2% by volume.

A twenty fifth aspect is directed to a method of forming a coated powder, the method including mixing nickel-containing particles with a colloidal solution containing metal oxide particles that are not miscible with nickel to thereby coat the particles with the metal oxide, wherein the coated particles comprise at least about 50% by weight nickel and the metal oxide that is not miscible with nickel dispersed in an amount in a range from about 0.2 to about 15% by volume.

In a twenty sixth aspect according to the twenty fifth aspect, the metal oxide is selected from the group consisting of zirconia, ceria, yttria, tantalum(V) oxide, and combinations thereof.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an exemplary illustration of a powder having metal oxide that is not miscible with nickel intradispersed therein;

FIG. 2 is an exemplary illustration of a powder having metal oxide that is not miscible with nickel interdispersed therein;

FIG. 3 schematically depicts the structure of a mold pre-oxidation for shaping glass-based materials, according to one or more embodiments shown and described herein;

FIG. 4 schematically depicts the structure of a mold post-oxidation for shaping glass-based materials, according to one or more embodiments shown and described herein;

FIG. 5 is a view of an exemplary nickel oxide layer surface taken with a confocal microscope.

### DETAILED DESCRIPTION

Reference will now be made in detail to various embodiments of powders that may be used for making a mold and molds made from such powders, examples of which are illustrated in the accompanying drawings. Whenever possible, the same reference numerals will be used throughout the drawings to refer to the same or like parts.

The following description is provided as an enabling teaching. To this end, those skilled in the relevant art will recognize and appreciate that many changes can be made to the various embodiments described herein, while still obtaining the beneficial results. It will also be apparent that some of the desired benefits can be obtained by selecting some of the features without utilizing other features. Accordingly, those who work in the art will recognize that many modifications and adaptations to the present embodiments are possible and can even be desirable in certain circumstances and are a part of the present description. Thus, the following description is provided as illustrative and should not be construed as limiting.

In this specification and in the claims which follow, reference will be made to a number of terms which shall be defined to have the meanings detailed herein.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, the term “glass-based” includes glass and glass-ceramic materials.

As used herein, the term “substrate” describes a glass-based sheet that may be formed into a three-dimensional structure.

Generally, disclosed herein are powders useful for making a mold, for example a mold for shaping a glass-based material. Glass-based articles formed using the molds made from the powders described herein may have a reduced number of defects introduced into the glass-based article during the shaping process. Thus, a desired surface quality of the shaped glass-based article may be achieved without further reworking or polishing of the as-formed surface. Glass-based material that is molded may have defects, including, but not limited to dimples (depressions in the glass-based surface), surface checks/cracks, blisters, chips, cords, dice, observable crystals, laps, seeds, stones, orange peel defects (imprint of large oxide grains on formed glass-based material, and pits in the formed glass-based material from raised areas on the mold surface, such as grain boundary areas, for example pits having 0.1 micron in height with a diameter greater than 30 microns), and stria. Molds made from powders described herein may be oxidized to provide a metal oxide layer having controlled grain sizes, which in turn can minimize the number of defects imprinted on a glass-based material from the mold surface during shaping. Thus, the compositions of the powders disclosed herein may be selected so that when the powders are compacted into an article and then machined into molds, the powder composition may control the size of the grains on a metal oxide layer formed on the mold.

In some embodiments, the powder includes at least about 50% by weight nickel. Metal oxides that are not miscible with nickel may be dispersed within the powder in an amount in a range from about 0.2 to about 15% by volume.

Nickel has been found to be a suitable metal for a mold used in shaping glass-based materials. When the nickel-containing mold surface is oxidized to form a nickel oxide layer, the nickel oxide layer provides high resistance to the sticking of glass-based materials under the high temperature conditions (e.g., typically in a range from 750 to 825° C.) needed to shape the glass-based materials. Thus, the nickel content in a powder used to form a mold used in shaping glass-based materials should be controlled. In some embodiments, the powder may include at least about 50%, about 55%, about 60%, about 65%, about 70%, about 75%, about 80%, about 85%, about 90%, about 95%, about 99%, about 99.5%, about 99.9% by weight nickel. In some embodiments, the powder may include at least about 50% to about 99.9%, about 50% to about 99.5%, about 50% to about 99%, about 50% to about 95%, about 50% to about 90%, about 50% to about 85%, about 50% to about 80%, about 50% to about 75%, about 50% to about 70%, about 50% to about 65%, about 50% to about 60%, about 50% to about 55%, about 55% to about 99.9%, about 55% to about 99.5%, about 55% to about 99%, about 55% to about 95%, about 55% to about 90%, about 55% to about 85%, about 55% to about 80%, about 55% to about 75%, about 55% to about 70%, about 55% to about 65%, about 55% to about 60%, about 60% to about 99.9%, about 60% to about 99.5%, about 60% to about 99%, about 60% to about 95%, about 60% to about 90%, about 60% to about 85%, about 60% to about 80%, about 60% to about 75%, about 60% to about 70%, about 60% to about 65%, about 65% to about 99.9%, about 65% to about 99.5%, about 65% to about 99%, about 65% to about 95%, about 65% to about 90%, about 65% to about 85%, about 65% to about 80%, about 65% to about 75%, about 65% to about 70%, about 70% to about 99.9%, about 70% to about 99.5%, about 70% to about 99%, about 70% to about 95%, about 70% to about 90%, about 70% to about 85%, about 70% to about 80%, about 70% to about 75%, about 75% to about 99.9%, about 75% to about 99.5%, about 75% to about 99%, about 75% to about 95%, about 75% to about 90%, about 75% to about 85%, about 75% to about 80%, about 80% to about 99.9%, about 80% to about 99.5%, about 80% to about 99%, about 80% to about 95%, about 80% to about 90%, about 80% to about 85%, about 85% to about 99.9%, about 85% to about 99.5%, about 85% to about 99%, about 85% to about 95%, about 85% to about 90%, about 90% to about 99.9%, about 90% to about 99.5%, about 90% to about 99%, about 90% to about 95%, about 95% to about 99.9%, about 95% to about 99.5%, or about 95% to about 99% by weight nickel. The nickel content may be determined using inductively coupled plasma optical emission spectroscopy (ICP-OES).

In some embodiments, the nickel in the powder may come from a commercially pure nickel grade, a nickel alloy, or a combination thereof. Exemplary commercially pure nickel grades include, but are not limited to, nickel 200, 201, 205, 212, 222, 233, and 270. Exemplary nickel alloys include, but are not limited to, alloys containing nickel, chromium and iron as main constituents with minor additions of Mo, Nb, Co, Mn, Cu, and the like. Suitable nickel alloys may include Hastelloy® and Inconel® nickel alloys, for example Inconel® 718.

Dispersing metal oxides in the powder that are not miscible with nickel is believed to control the size of grains that form on the surface of a mold made from the powders, which in turn is believed to minimize an orange peel effect on glass-based materials shaped using the molds formed from the powders. In some embodiments, metal oxides that are not miscible with nickel that are dispersed in the powder may include, but are not limited to, zirconia, ceria, yttria, tantalum(V) oxide, and combinations thereof. As used herein, the phrase “the metal oxides are not miscible with nickel” means the metal oxides and nickel remain as separate phases. In some embodiments, the powder contains metal oxides that are not miscible with nickel dispersed within the powder in an amount of at least about 0.2%, about 0.5%, about 0.7%, about 1%, about 2%, about 3%, about 4%, about 5%, about 6%, about 7%, about 8%, about 9%, about 10%, about 11%, about 12%, about 13%, about 14%, or about 15% by volume. In some embodiments, the powder contain metal oxides that are not miscible with nickel dispersed within the powder in an amount in a range from about 0.2% to about 15%, about 0.2% to about 12%, about 0.2% to about 10%, about 0.2% to about 9%, about 0.2% to about 8%, about 0.2% to about 7%, about 0.2% to about 6%, about 0.2% to about 5%, about 0.2% to about 4%, about 0.2% to about 3%, about 0.2% to about 2%, about 0.2% to about 1%, about 0.2% to about 0.7%, about 0.2% to about 0.5%, about 0.5% to about 15%, about 0.5% to about 12%, about 0.5% to about 10%, about 0.5% to about 9%, about 0.5% to about 8%, about 0.5% to about 7%, about 0.5% to about 6%, about 0.5% to about 5%, about 0.5% to about 4%, about 0.5% to about 3%, about 0.5% to about 2%, about 0.5% to about 1%, about 0.5% to about 0.7%, about 0.7% to about 15%, about 0.7% to about 12%, about 0.7% to about 10%, about 0.7% to about 9%, about 0.7% to about 8%, about 0.7% to about 7%, about 0.7% to about 6%, about 0.7% to about 5%, about 0.7% to about 4%, about 0.7% to about 3%, about 0.7% to about 2%, about 0.7% to about 1%, about 1% to about 15%, about 1% to about 12%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 12%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 12%, about 3% to about 10%, about 3% to about 9%, about 3% to about 8%, about 3% to about 7%, about 3% to about 6%, about 3% to about 5%, about 3% to about 4%, about 4% to about 15%, about 4% to about 12%, about 4% to about 10%, about 4% to about 9%, about 4% to about 8%, about 4% to about 7%, about 4% to about 6%, about 4% to about 5%, about 5% to about 15%, about 5% to about 12%, about 5% to about 10%, about 5% to about 9%, about 5% to about 8%, about 5% to about 7%, about 5% to about 6%, about 6% to about 15%, about 6% to about 12%, about 6% to about 10%, about 6% to about 9%, about 6% to about 8%, about 6% to about 7%, about 7% to about 15%, about 7% to about 12%, about 7% to about 10%, about 7% to about 9%, about 7% to about 8%, about 8% to about 15%, about 8% to about 12%, about 8% to about 10%, about 8% to about 9%, about 9% to about 15%, about 9% to about 12%, about 9% to about 10%, about 10% to about 15%, about 10% to about 12%, or about 12% to about 15% by volume. The content of the metal oxide may be determined using inductively coupled plasma optical emission spectroscopy (ICP-OES). In some embodiments, the metal oxide that is not miscible with nickel may be dispersed in the powder through interdispersion, intradispersion, or a combination thereof. As used herein, a metal oxide is interdispersed in the powder, if the powder particles are coated with the metal oxide. In some embodiments, a metal oxide may be interdispersed in the powder through a colloidal coating method. In such embodiments, nickel-containing particles were mixed with a colloidal solution containing metal oxide particles. The colloidal solution may include water loaded with the metal oxide particles. The load (weight % of metal oxide compared to the nickel-containing particles) may be calculated according to the following formula:

Load=6ρₒthk/ρₙd (1)

### Wherein

d is the nickel-containing particle diameter in m

thk is the average metal oxide particle thickness in m

ρₙ is the nickel-containing particle density in kg/m³

ρₒ is the metal oxide particle density in kg/m³.

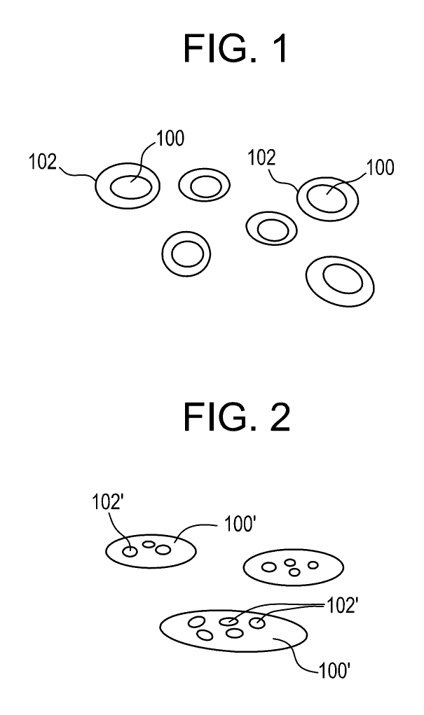

In some embodiments, the metal oxide particles may be spherical nanoparticles having an average diameter in a range from about 10 nm to about 20 nm. In some embodiments, the nickel-containing particles may have an average diameter of about 20 microns. In some embodiments, the colloidal solution may be added to the nickel-containing particles until a paste-like consistency is achieved. The mixture may be mixed for a suitable period and then dried to remove the water. As shown in FIG. 1, after the colloidal-coating process, the powder includes nickel-containing particles 100 uniformly coated with the metal oxide 102.

As used herein, a metal oxide is intradispersed in the powder, if the metal oxide is within an interior of powder particles. In some embodiments, a metal oxide may be intradispersed in the powder through conventional mechanical alloying methods. For example, a mixture of nickel-containing particles and metal oxides particles may be milled together such that the metal oxide particles are mixed into the interior of the nickel-containing particles. FIG. 2 is an exemplary illustration of a powder having nickel-containing particles 100′ with metal oxide 102′ intradispersed therein. In some embodiments, the powder includes a plurality of particles and the average particle size is in a range from about 5 nm to about 1,000 nm, about 5 nm to about 750 nm, about 5 nm to about 500 nm, about 5 nm to about 250 nm, about 5 nm to about 100 nm, about 5 nm to about 50 nm, about 5 nm to about 25 nm, about 25 nm to about 1,000 nm, about 25 nm to about 750 nm, about 25 nm to about 500 nm, about 25 nm to about 250 nm, about 25 nm to about 100 nm, about 25 nm to about 50 nm, about 50 nm to about 1,000 nm, about 50 nm to about 750 nm, about 50 nm to about 500 nm, about 50 nm to about 250 nm, about 50 nm to about 100 nm, about 100 nm to about 1,000 nm, about 100 nm to about 750 nm, about 100 nm to about 500 nm, about 100 nm to about 250 nm, about 250 nm to about 1,000 nm, about 250 nm to about 750 nm, about 250 nm to about 500 nm, about 500 nm to about 1,000 nm, about 500 nm to about 750 nm, or about 750 nm to about 100 nm. The average particle size may be determined by measuring the longest dimension using laser light diffraction.

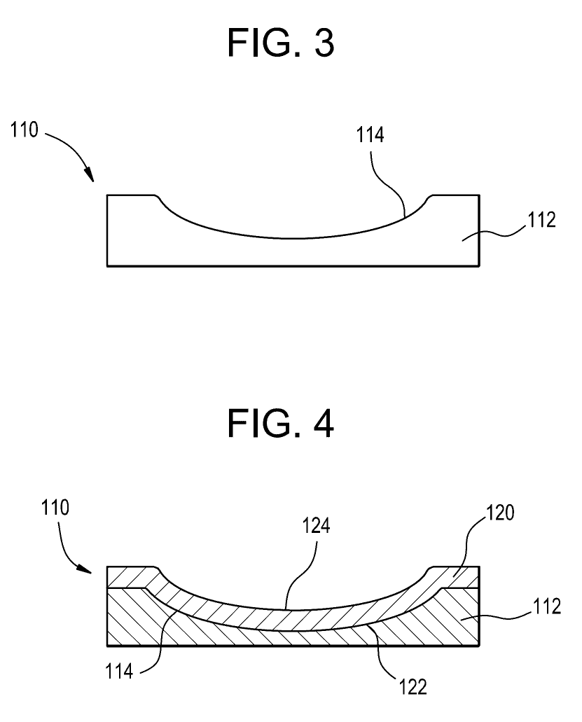

In some embodiments, the powder may be formed into a mold using conventional techniques including compacting and sintering the powder through hot isostatic pressing to form a block and then machining the block to a desired mold shape. Thus the powder can be formed into an article, such as a block, and then machined to a desired mold shape. An exemplary mold 110, as shown in FIG. 3, can include a mold body 112 having an outer surface 114. It should be understood that outer surface 114 of mold body 112 can have a wide variety of shapes to form varying three dimensionally shaped glass-based articles.

In some embodiments, an article or mold formed from the powder may have the same amount of nickel and the same amount of metal oxide that is not miscible in nickel as the powder. Thus, in some embodiments, the article or mold may include at least about 50%, about 55%, about 60%, about 65%, about 70%, about 75%, about 80%, about 85%, about 90%, about 95%, about 99%, about 99.5%, about 99.9% by weight nickel. In some embodiments, the article or mold may include at least about 50% to about 99.9%, about 50% to about 99.5%, about 50% to about 99%, about 50% to about 95%, about 50% to about 90%, about 50% to about 85%, about 50% to about 80%, about 50% to about 75%, about 50% to about 70%, about 50% to about 65%, about 50% to about 60%, about 50% to about 55%, about 55% to about 99.9%, about 55% to about 99.5%, about 55% to about 99%, about 55% to about 95%, about 55% to about 90%, about 55% to about 85%, about 55% to about 80%, about 55% to about 75%, about 55% to about 70%, about 55% to about 65%, about 55% to about 60%, about 60% to about 99.9%, about 60% to about 99.5%, about 60% to about 99%, about 60% to about 95%, about 60% to about 90%, about 60% to about 85%, about 60% to about 80%, about 60% to about 75%, about 60% to about 70%, about 60% to about 65%, about 65% to about 99.9%, about 65% to about 99.5%, about 65% to about 99%, about 65% to about 95%, about 65% to about 90%, about 65% to about 85%, about 65% to about 80%, about 65% to about 75%, about 65% to about 70%, about 70% to about 99.9%, about 70% to about 99.5%, about 70% to about 99%, about 70% to about 95%, about 70% to about 90%, about 70% to about 85%, about 70% to about 80%, about 70% to about 75%, about 75% to about 99.9%, about 75% to about 99.5%, about 75% to about 99%, about 75% to about 95%, about 75% to about 90%, about 75% to about 85%, about 75% to about 80%, about 80% to about 99.9%, about 80% to about 99.5%, about 80% to about 99%, about 80% to about 95%, about 80% to about 90%, about 80% to about 85%, about 85% to about 99.9%, about 85% to about 99.5%, about 85% to about 99%, about 85% to about 95%, about 85% to about 90%, about 90% to about 99.9%, about 90% to about 99.5%, about 90% to about 99%, about 90% to about 95%, about 95% to about 99.9%, about 95% to about 99.5%, or about 95% to about 99% by weight nickel. Also, the article or mold may include metal oxides that are not miscible with nickel in an amount in a range from about 0.2% to about 15%, about 0.2% to about 12%, about 0.2% to about 10%, about 0.2% to about 9%, about 0.2% to about 8%, about 0.2% to about 7%, about 0.2% to about 6%, about 0.2% to about 5%, about 0.2% to about 4%, about 0.2% to about 3%, about 0.2% to about 2%, about 0.2% to about 1%, about 0.2% to about 0.7%, about 0.2% to about 0.5%, about 0.5% to about 15%, about 0.5% to about 12%, about 0.5% to about 10%, about 0.5% to about 9%, about 0.5% to about 8%, about 0.5% to about 7%, about 0.5% to about 6%, about 0.5% to about 5%, about 0.5% to about 4%, about 0.5% to about 3%, about 0.5% to about 2%, about 0.5% to about 1%, about 0.5% to about 0.7%, about 0.7% to about 15%, about 0.7% to about 12%, about 0.7% to about 10%, about 0.7% to about 9%, about 0.7% to about 8%, about 0.7% to about 7%, about 0.7% to about 6%, about 0.7% to about 5%, about 0.7% to about 4%, about 0.7% to about 3%, about 0.7% to about 2%, about 0.7% to about 1%, about 1% to about 15%, about 1% to about 12%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 12%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 12%, about 3% to about 10%, about 3% to about 9%, about 3% to about 8%, about 3% to about 7%, about 3% to about 6%, about 3% to about 5%, about 3% to about 4%, about 4% to about 15%, about 4% to about 12%, about 4% to about 10%, about 4% to about 9%, about 4% to about 8%, about 4% to about 7%, about 4% to about 6%, about 4% to about 5%, about 5% to about 15%, about 5% to about 12%, about 5% to about 10%, about 5% to about 9%, about 5% to about 8%, about 5% to about 7%, about 5% to about 6%, about 6% to about 15%, about 6% to about 12%, about 6% to about 10%, about 6% to about 9%, about 6% to about 8%, about 6% to about 7%, about 7% to about 15%, about 7% to about 12%, about 7% to about 10%, about 7% to about 9%, about 7% to about 8%, about 8% to about 15%, about 8% to about 12%, about 8% to about 10%, about 8% to about 9%, about 9% to about 15%, about 9% to about 12%, about 9% to about 10%, about 10% to about 15%, about 10% to about 12%, or about 12% to about 15% by volume.

Molds for shaping a glass-based material often have a metal oxide layer formed on the outer surface of the mold body to prevent sticking of the glass-based material to the mold during shaping. The metal oxide layer is often formed by subjecting the outer surface of the mold body to an oxidation treatment. Thus, in some embodiments, a metal oxide layer 120 may be formed on mold body 110 by exposing surface 114 of mold body 110 to an oxidizing heat treatment. FIG. 4 shows an exemplary mold 100 having a metal oxide layer 120 having a first surface 122 adjacent metal surface 114 and an opposing second surface 124 forming the outer surface of mold 110. The metal of the metal oxide layer is the metal of the mold. For example, when mold 100 is predominantly nickel, metal oxide layer 120 will be a nickel oxide layer. The oxidizing heat treatment may include exposing the mold 100 to elevated temperatures sufficient to convert at least a portion of the metal, for example nickel, at surface 114 of mold body 112. An exemplary oxidizing heat treatment can include that disclosed in Pub. No. US 2014-0202211 A1, which is hereby incorporated by reference in its entirety.

Metal oxide layer 120 formed on surface 114 of mold body 112 may have an average thickness of from about 500 nm to about 20 micron, about 1 micron to about 14 micron, about 1 micron to about 10 micron, about 1 micron to about 8 micron, about 1 micron to about 6 micron, about 1 micron to about 4 micron, about 4 micron to about 20 micron, about 4 micron to about 14 micron, about 4 micron to about 10 micron, about 4 micron to about 8 micron, about 4 micron to about 6 micron, about 6 micron to about 20 micron, about 6 micron to about 14 micron, about 6 micron to about 10 micron, about 6 micron to about 8 micron, about 8 micron to about 20 micron, about 8 micron to about 14 micron, or about 8 micron to about 10 micron. In some embodiments, the nickel oxide layer 120 on the mold 110 may have an average thickness of about 100 nm or less, about 200 nm or less, about 300 nm or less, about 400 nm or less, about 500 nm or less, about 750 nm or less, about 1 micron or less, about 2 micron or less, about 3 micron or less, about 4 micron or less, about 5 micron or less, about 6 micron or less, about 7 micron or less, about 8 micron or less, about 9 micron or less, about 10 micron or less, about 12 micron or less, about 15 micron or less, about 18 micron or less, or about 20 micron or less.

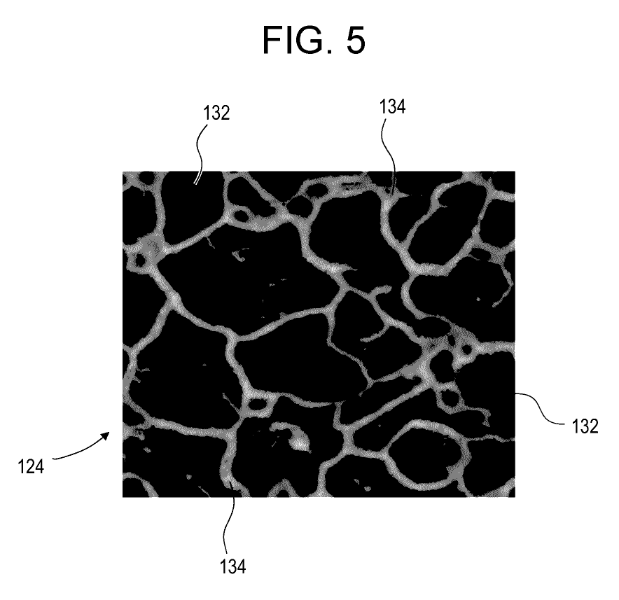

In some embodiments, the article or mold formed from the powder includes grains. In some embodiments, wherein the article is a mold, the grains can grow during the oxidizing heat treatment. As shown for example in FIG. 5, the presence of grains forms two types of areas on the surface of an article or mold formed from the powder—a grain body area 132 and a grain boundary area 134. When the article is a mold and a mold surface is oxidized, the grains grow during the oxidizing heat treatment. During formation of nickel oxide layer 120, the nickel oxide can form faster on grain boundary areas 134 than on grain body areas 132. As a result, areas of surface 124 corresponding to grain boundary areas 134 will be raised relative to areas of surface 124 corresponding to grain body areas 132. During shaping of glass-based materials, the glass-based materials will contact the raised grain boundary areas 134 of mold 110 first when being shaped, potentially causing the pattern of the grain boundary areas 134 to be imprinted on the surface of the glass-based material depending upon the size of grain boundary areas 134. It has been found that reducing the size of the grain bodies, increases the percentage of the grain boundary areas 134 on surface 124. Increasing the area of the grain boundary areas 134 results in lower localized pressure at the glass-based material/grain boundary interface during shaping. The lower the localized pressure, the less likely a grain boundary impression will be seen on the shaped glass-based material. It has also been found that reducing the height differential between grain body areas 132 and grain boundary areas 134 can also minimize the likelihood that a grain boundary impression will be seen on the shaped glass-based material. A controlled amount of metal oxides not miscible with nickel in the powder, for example, zirconia, ceria, yttria, tantalum(V) oxide, and combinations thereof, segregate at the grain boundaries to minimize or prevent grain growth by pinning the grain boundaries. The metal oxides not miscible with nickel may also slow down the diffusion of nickel through the grain boundary areas to form the oxide layer and in turn that slows the formation of the nickel oxide layer at the grain boundary areas, thereby minimizing the grain boundary height differential. The metal oxides not miscible with nickel pinning down the grain boundaries may also (1) minimize or prevent growth of very large grains which can produce orange peel imprints on glass-base materials shaped with the mold that cannot be removed by polishing the glass and (2) maintain the grain size over the life of the mold.

In some embodiments, minimizing the impact of grain boundary impressions on glass-based materials shaped on mold 100 can be achieved by controlling the average grain size and/or an average height differential between the grain body areas and the grain boundary areas on surface 124 of metal oxide layer 120. As noted above, the average grain size and average height differential can be controlled based on the amount of metal oxides not miscible with nickel present in the mold. In some embodiments, the average grain size making up each grain body area 132 on surface 124 can be about 200 μm or less, about 175 μm or less, about 150 μm or less, about 145 μm or less, about 140 μm or less, about 135 μm or less, about 130 μm or less, about 125 μm or less, about 120 μm or less, about 115 μm or less, about 110 μm or less, about 105 μm or less, about 100 μm or less, about 95 μm or less, about 90 μm or less, about 85 μm or less, about 80 μm or less, about 75 μm or less, about 70 μm or less, about 65 μm or less, about 60 μm or less, about 55 μm or less, about 50 μm, about 45 μm or less, about 40 μm or less, about 35 μm or less, about 30 μm or less, about 25 μm or less, about 20 μm or less, about 15 μm or less, about 10 μm or less, or about 5 um or less. The average grain size can be determined by measuring the diameter of each grain at its widest point over a field of view and calculating the average value. The average grain size can be determined using image analysis software, such as Nikon Elements. The magnification can be 100× and the field of view can be 1 mm by 1 mm. The average grain size can be calculated based on 3 fields of view. In some embodiments, the average size of the grains making up each grain body area 132 on surface 124 of metal oxide layer 120 can be about 3 or above, about 4 or above, about 5 or above, about 6 or above, about 7 or above, about 8 or above, about 9 or above, about 10 or above, or about 11 or above as measured using ASTM E112-13 and its progeny. The larger the value for ASTM E112-13, the smaller the average grain size. The benefits of a smaller grain size are discussed above.

In some embodiments, the average height differential between grain body areas 132 and grain boundary areas 134 on surface 124 of metal oxide layer 120 can be about 2 μm or less, 1.75 μm or less, about 1.5 μm or less, about 1.25 μm or less, about 1 μm or less, about 0.75 μm or less, about 0.5 μm or less, or about 0.25 μm or less. In some embodiments, the average height differential can be measured by determining the average peak surface roughness (Rₚ) on surface 124 of metal oxide layer 120. In some embodiments, this average surface roughness (Rₚ) is determined over an evaluation length, such as 100 μm, 10 mm, 100 mm, 1 cm, etc. As used herein, Rₚ is defined as the difference between the maximum height and the average height and can be described by the following equation:

$${R}_{p} = {max}_{i} {y}_{i} ,$$

where yᵢ is the maximum height relative to the average surface height. The Rₚ can be measured using a confocal microscope, such as one available from Zeiss, or an optical profilometer, such as one available from Zygo.

In some embodiments, nickel oxide layer 120 may have an average surface roughness (Rₐ) of less than or equal to about 1 micron on surface 124. In some embodiments, this average surface roughness (Rₐ) is determined over an evaluation length, such as 100 μm, 10 mm, 100 mm, etc. or may be determined based on an analysis of the entire surface 124 of nickel oxide layer 120. As used herein, Rₐ is measured over a 260 μm×350 μm sized area and defined as the arithmetic average of the differences between the local surface heights and the average surface height and can be described by the following equation:

$${R}_{a} = \frac{1}{n} {\sum }_{i = 1}^{n} \vert {y}_{i} \vert ,$$

where yᵢ is the local surface height relative to the average surface height. In other embodiments Rₐ may be less than or equal to about 1 μm, 0.9 μm, 0.8 μm, 0.7 μm, 0.6 μm, 0.5 μm, 0.4 μm, 0.35 μm 0.3 μm, 0.25 μm, 0.2 μm, 0.15 μm or 0.1 μm over an evaluation length of 10 mm. In some embodiments, Rₐ may be in a range from about 0.1 μm to about 1 μm, about 0.1 μm to about 0.5 μm, about 0.1 μm to about 0.4 μm, about 0.1 μm to about 0.3 μm, 0.15 μm to about 1 μm, about 0.15 μm to about 0.5 μm, about 0.15 μm to about 0.4 μm, about 0.15 μm to about 0.3 μm, about 0.15 μm to about 0.25 μm, 0.2 μm to about 1 μm, about 0.2 μm to about 0.5 μm, about 0.2 μm to about 0.4 μm, or about 0.4 μm to about 1 μm over an evaluation length of 10 mm. The Rₐ can be measured using a confocal microscope, such as one available from Zeiss, or an optical profilometer, such as one available from Zygo.

In some embodiments, metal oxide layer 120 may have a waviness, Wₐ, which describes the arithmetic average peak-to-valley height of the waviness surface profile of surface 124. In some embodiments, the Wₐ is from about 1 nm to about 500 nm, about 1 nm to about 450 nm, about 1 nm to about 400 nm, about 1 nm to about 350 nm, about 1 nm to about 1 nm to about 300 nm, about 1 nm to about 250 nm, about 1 nm to about 200 nm, about 1 nm to about 150 nm, or about 1 nm to about 100 nm over an evaluation length of 1 cm. In some embodiments, the Wₐ is less than or equal to about 500 nm, 450 nm, 400 nm, 350 nm, 300 nm, 250 nm, 200 nm, 150 nm, 100 nm, 80 nm, 60 nm, 40 nm, 20 nm, 10 nm, 5 nm, 2 nm over an evaluation length of 1 cm. The Wₐ can be measured using a confocal microscope, such as one available from Zeiss, or an optical profilometer, such as one available from Zygo.

Embodiments of molds 110 described herein may be used in any forming processes, such as 3D glass forming processes. The molds 110 are especially useful in forming 3D glass articles when used in combination with the methods and devices described in U.S. Pat. Nos. 8,783,066 and 8,701,443, which are hereby incorporated by reference in their entireties.

Molds 110 described herein may be utilized in making glass-based articles by forming a glass-based article by contacting a glass-based material with mold 110 at a temperature sufficient to allow for shaping of the glass-based material. In some embodiments, molds 110 may be used in the following process: a typical thermal reforming process involves heating the 2D glass-based sheet to a forming temperature, e.g., a temperature in a temperature range corresponding to a glass viscosity of 10⁷ Poise to 10¹¹ Poise or between an annealing point and softening point of the glass, while the 2D glass-based sheet is on top of a mold 110. The heated 2D glass-based sheet may start sagging once heated. Typically, vacuum is then applied in between the glass-based sheet and mold 100 to conform the glass-based sheet to the surface 124 and thereby form the glass-based sheet into a 3D glass-based article. After forming the 3D glass-based article, the 3D glass-based article is cooled to a temperature below the strain point of the glass, which would allow handling of the 3D glass-based article.

The glass-based articles formed via the embodiments herein may be described by Publ. No. US 2013-0323444 A1. The three-dimensional (3D) glass-based articles can be used to cover an electronic device having a display, for example as part or all of the front, back, and or sides of the device. The 3D cover glass can protect the display while allowing viewing of and interaction with the display. If used as the front cover, the glass-based articles can have a front cover glass section for covering the front side of the electronic device, where the display is located, and one or more side cover glass sections for wrapping around the peripheral side of the electronic device. The front cover glass section can be made contiguous with the side cover glass section(s).

The preformed glass used to in the processes described herein typically starts as a two dimensional (2D) glass sheet. The 2D glass sheet may be made by a fusion or float process. In some embodiments, the 2D glass sheet is extracted from a pristine sheet of glass formed by a fusion process. The pristine nature of the glass may be preserved up until the glass is subjected to a strengthening process, such as an ion-exchange chemical strengthening process. Processes for forming 2D glass sheets are known in the art and high quality 2D glass sheets are described in, for example, U.S. Pat. Nos. 5,342,426, 6,502,423, 6,758,064, 7,409,839, 7,685,840, 7,770,414, and 8,210,001.

In one embodiment, the glass is made from an alkali aluminosilicate glass composition. An exemplary alkali aluminosilicate glass composition comprises from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %. This alkali aluminosilicate glass is described in U.S. Pat. No. 8,158,543.

Another exemplary alkali-aluminosilicate glass composition comprises at least about 50 mol % SiO₂ and at least about 11 mol % Na₂O, and the compressive stress is at least about 900 MPa. In some embodiments, the glass further comprises Al₂O₃ and at least one of B₂O₃, K₂O, MgO and ZnO, wherein −340+27.1·Al₂O₃−28.7·B₂O₃+15.6·Na₂O−61.4·K₂O+8.1·(MgO+ZnO)≧0 mol %. In particular embodiments, the glass comprises: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO. The glass is described in Pub. No. US 2013-0004758 A1, the contents of which are incorporated herein by reference in their entirety.

Other types of glass compositions besides those mentioned above and besides alkali-aluminosilicate glass composition may be used for the 3D cover glass. For example, alkali-aluminoborosilicate glass compositions may be used for the 3D cover glass. Preferably, the glass compositions used are ion-exchangeable glass compositions, which are generally glass compositions containing small alkali or alkaline-earth metals ions that can be exchanged for large alkali or alkaline-earth metal ions. Additional examples of ion-exchangeable glass compositions may be found in U.S. Pat. Nos. 7,666,511; 4,483,700; 5,674,790; 8,969,226; 8,158,543; 8,802,581; and 8,586,492, and Pub. No. US 2012-0135226 A1.

Various embodiments will be further clarified by the following examples.

### Example 1

Yttrium stabilized zirconia was intradispersed in a powder of nickel grade 110. The nickel powder had an average particle size in a range from 4-8 microns and was purchased from Micronmetals. The yttrium stabilized zirconia had an average particle size distribution of less than 45 microns and was also purchased from Micronmetals. A 1 liter crucible and 8 mm diameter zirconia milling balls were used in a Union Mill attritor to mechanically alloy the zirconia and the nickel powder. The Union Mill attritor was operated at a rotation speed of about 300 rpm for 6 hours to dry mill the zirconia and nickel so that the zirconia became intradispersed in the nickel powder. The resulting powder had an average particle size distribution of about 0.5 microns and contained about 99.5% by weight nickel and 0.3% by weight zirconia.

After milling the powder was subjected to hot isostatic pressing at about 15,000 psi at about 1150° C. for about 6 hours to compact the powder and form a substrate. Various spots at grain boundaries and in the grain body were analyzed and as would be expected from a substrate formed from a powder intradispersed with zirconia, zirconia was present at the grain boundaries and in the grain body.

### Example 2

Ceria was interdispersed in a powder of nickel grade 110. The nickel powder had an average particle size of less than 45 microns. The ceria had a particle size ranging from 10 to 20 nm. A colloidal solution of water and ceria stabilized at a pH of 3.5 with acetate was added to the nickel powder up to a level leading to a paste-like consistency (about 10 wt % solution). The combination was then mixed with a spatula for about 2 minutes and dried for about 24 hours at room temperature and then heated for about 8 hours at 120° C. to remove all water content. The resultant powder contained nickel particles coated in ceria.

After drying the powder was subjected to cold isostatic pressure at 18,000 psi at room temperature and then sintering at 1200° C. for about 8 hours in a reduced atmosphere having 96% N₂ and 4% H₂ to form a substrate. Various spots at grain boundaries and in the grain body were analyzed and as would be expected from a substrate formed from a powder interdispersed with ceria, ceria was present at the grain boundaries.

It will be apparent to those skilled in the art that various modifications and variations can be made without departing from the spirit or scope of the invention.

What is claimed is:

1. A powder comprising:
at least about 50% by weight nickel; and
a metal oxide that is not miscible with nickel dispersed within the powder in an amount in a range from about 0.2 to about 15% by volume.

2. The powder of claim 1, wherein the metal oxide is selected from the group consisting of zirconia, ceria, yttria, tantalum(V) oxide, and combinations thereof.

3. The powder of claim 1, further comprising a plurality of particles, wherein an average particle size of the powder is in a range from about 5 nm to about 1,000 nm.

4. The powder of claim 1, further comprising a plurality of particles, wherein the oxide is interdispersed with the nickel.

5. The powder of claim 4, wherein the particles are coated with the oxide.

6. The powder of claim 1, further comprising a plurality of particles, wherein the oxide is intradispersed with the nickel.

7. The powder of claim 6, wherein the oxide is within an interior of the particles.

8. The powder of claim 1, further comprising a plurality of particles, wherein the oxide is interdispersed with the nickel in a first portion of the plurality of particles and intradispersed with the nickel in a second portion of the plurality of particles.

9. The powder of claim 1, wherein the oxide is dispersed within the powder in an amount in a range from about 0.2 to about 2% by volume.

10. The powder of claim 1, wherein the oxide is zirconia.

11. The powder of claim 1, wherein the oxide is ceria.

12. An article comprising:
at least 50% by weight nickel;
a metal oxide that is not miscible with nickel in an amount in a range from about 0.2 to about 15% by volume; and
a plurality of grains, wherein the plurality of grains has an average grain size of about 100 μm or less.

13. The article of claim 12, wherein the metal oxide is selected from the group consisting of zirconia, ceria, yttria, tantalum(V) oxide, and combinations thereof.

14. The article of claim 12, wherein the plurality of grains has an average grain size of about 50 μm or less.

15. The article of claim 12, wherein the oxide is in an amount in a range from about 0.2 to about 2% by volume.

16. The article of claim 12, wherein the oxide is zirconia.

17. The article of claim 12, wherein the oxide is ceria.

18. A mold comprising:
a mold body having a composition comprising at least 50% by weight nickel and a metal oxide that is not miscible with nickel in an amount in a range from about 0.2 to about 15% by volume; and
a nickel oxide layer on a surface of the mold body wherein the nickel oxide layer has first and second opposing surfaces, the first surface of the nickel oxide layer contacts and faces the surface of the mold body.

19. The mold of claim 18, wherein the second surface of the nickel oxide layer includes a plurality of grains, and the plurality of grains has an average grain size of about 100 μm or less.

20. The mold of claim 19, wherein the plurality of grains has an average grain size of about 50 μm or less.

21. The mold of claim 18, wherein the metal oxide is selected from the group consisting of zirconia, ceria, yttria, tantalum(V) oxide, and combinations thereof.

22. The mold of claim 18, wherein the oxide is in an amount in a range from about 0.2 to about 2% by volume.

23. The mold of claim 18, wherein the oxide is zirconia.

24. The mold of claim 18, wherein the oxide is ceria.

25. A method of forming a coated powder, the method comprising:
mixing nickel-containing particles with a colloidal solution containing metal oxide particles that are not miscible with nickel to thereby coat the particles with the metal oxide,
wherein the coated particles comprise at least about 50% by weight nickel and the metal oxide that is not miscible with nickel dispersed in an amount in a range from about 0.2 to about 15% by volume.

26. The method of claim 25, wherein the metal oxide is selected from the group consisting of zirconia, ceria, yttria, tantalum(V) oxide, and combinations thereof.
